(19) United States
(12) Patent Application Publication
(10) Pub. No.: US 2003/0081652 A1
(43) Pub. Date: May 1, 2003

(54) Composite wire, particularly connection wire for temperature sensors

(75) Inventors: Karl-Heinz Wienand, Achaffenburg (DE); Karlheinz Ullrich, Gross-Umstadt (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: HERAEUS SENSOR-NITE GMBH

(21) Appl. No.: 10/280,527

(22) Filed: Oct. 25, 2002

(30) Foreign Application Priority Data
Oct. 31, 2001 (DE) 101 53 217.2

(51) Int. Cl. G01K 7/00

(52) U.S. Cl. 374/185; 374/163

(57) ABSTRACT

A composite wire is provided as a connection wire for electric temperature sensors, the wire having a core made of a nickel-based alloy which self-passivates at the core surface, wherein the core has a jacket made of platinum. A suitable nickel-based alloy which self-passivates at the core surface contains chromium in a range of about 16 to 22-wt %, preferably about 20-wt %.

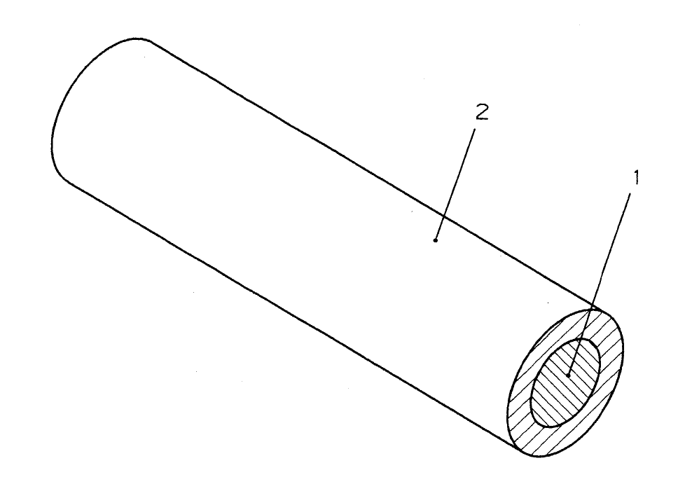

### BACKGROUND OF THE INVENTION

This invention relates to composite or coated wires, in particular connection wires for electrical temperature sensors, in which the wires have a platinum-containing jacket that encloses an alloy core. Moreover, the invention relates to the use of such a composite wire.

From German Patent DE 38 32 342 C1 a composite wire is known having a jacket made of platinum that encloses a core made of a palladium alloy with 1-5 wt % tungsten. The jacket volume alone amounts to 10-50% per unit length based on the overall volume of the composite wire. To manufacture it, a rod-shaped core material made of a palladium alloy containing 1-5 wt % tungsten is inserted into a tube made of platinum, and this rod-tube arrangement is drawn to a final wire diameter. Such composite wires are preferably used as connection lines or supply wires for resistance thermometers having a measuring resistor made of platinum.

The relatively low upper temperature limit (in practice approximately 600° C.) has been shown to be a problem, resulting in only a limited area of application. At elevated temperatures one must take into account that the material of the core diffuses through the platinum jacket and oxidizes on the outermost surface. This reduces the electrical contact to a chip terminal (terminal pad), thereby also reducing the required mechanical stability. Moreover, the relatively high material costs, in practice, must be considered as a problem.

Similar problems also occur with the composite wires disclosed in German published patent application DE 41 25 960 A1, which have a nickel core and a platinum jacket, which has a gold layer on its surface. Composite wires of this type are preferably used as connection lines or supply wires for layer-shaped measuring resistors, in particular for measuring resistors used for temperature measurement.

British patent specification GB 400,808 describes a process to manufacturing wires with noble metal jackets for dental uses. Here, the description also discloses composite wires for other, non-specified uses, which have a core made of a nickel alloy and a jacket made of platinum. The following nickel alloys are cited as core materials for the dental applications:

nickel alloy with 1% manganese and approximately 0.5% silicon,

nickel alloy with 55% nickel and 45% iron, and

nickel alloy with manganese, aluminum, iron and silicon in amounts up to 5%. This core material is coated with an intermediate layer of platinum, rhodium, palladium or a noble metal alloy, such as silver-palladium or gold-palladium, which layer is in turn coated with a covering layer of gold.

### BRIEF SUMMARY OF THE INVENTION

An object of the present invention is to create platinum composite wires, which maintain their stability even when used at temperatures above about 550° C. This object is achieved, according to the invention, by the core being made of a nickel-based alloy which self-passivates at the core surface, and by the nickel-based alloy containing a portion of chromium in a range of about 16 to 22 wt %.

The object is further achieved, according to the invention, by the core being made of a nickel-based alloy which self-passivates at the core surface, and by the nickel-based alloy also having an iron portion in addition to the chromium portion. It is especially preferred here if the iron portion of the nickel-based alloy lies in a range of about 0.5 to 10 wt %, preferably about 8 wt %.

The object is still further achieved, according to the invention, by the core being made of a nickel-based alloy which self passivates at the core surface, and by the nickel-based alloy also having an aluminum portion. It is especially preferred here if the aluminum portion of the nickel-based alloy lies in a range of about 0.05 to 5 wt %.

### BRIEF DESCRIPTION OF THE SEVERAL VIEWS OF THE DRAWINGS

The foregoing summary, as well as the following detailed description of the invention, will be better understood when read in conjunction with the appended drawing. For the purpose of illustrating the invention, there is shown in the drawing an embodiment which is presently preferred. It should be understood, however, that the invention is not limited to the precise arrangement and instrumentality shown. In the drawing:

The sole FIGURE is a perspective view in end section of a piece composite wire according to the present invention.

### DETAILED DESCRIPTION OF THE INVENTION

When the nickel-based alloy contains chromium and iron as the alloying elements or aluminum as the alloying element, a portion of chromium in a range of about 16 to 22 wt % has been shown to be beneficial. In particular, a portion of chromium in an amount of about 20 wt % is preferred for the composite wires according to the invention.

An outer jacket diameter of about 0.05 to 0.4 mm, preferably about 0.2 mm, has been shown to be beneficial. It is advantageous if the platinum portion (per unit length) lies in a range of about 10 to 50 wt %.

A composite wire of this type has tensile strengths in a range of about 400 to 1200 N/mm², wherein the elastic limit lies in a range of about 175 to 250 N/mm² and an elongation at break of about 15 to 35% is attained.

An important advantage of these composite wires is that the nickel-based alloy, which self-passivates at the core surface, slows down or prevents both the inner oxidation of the core and the formation of an outer nickel oxide skin layer on the platinum jacket at temperatures above about 550° C. The diffusion of nickel through the platinum jacket, its oxidation on the jacket surface, and the occurrence of the problems described above are substantially prevented.

An important feature of the invention is that the passivation of the core surface maintains the function of the platinum jacket for a long time as a noble metal, high-temperature resistant, tractable protection, as for example upon bonding or welding. Additional gold layers, that increase the price of the composite wire, are thereby obviated.

An ideal use of a composite wire having a platinum-containing jacket which encloses a core made of an alloy, wherein the core comprises a nickel-based alloy which self-passivates at the core surface, is as a connection wire for electrical temperature sensors.

An important advantage of the use of such composite wires as connection wires for electrical temperature sensors is that the nickel-based alloy which self-passivates at the core surface slows down or prevents both the inner oxidation of the core and the formation of an outer nickel oxide skin on the platinum jacket at temperatures above about 550° C. Nickel is substantially prevented from diffusing through the platinum jacket and oxidizing on the jacket surface, which would otherwise result in the problems described above.

Especially beneficial is a nickel-based alloy having a portion of chromium in a range of about 16 to 22 wt %, in particular in an amount of about 20 wt %.

It is advantageous if a nickel-based alloy is used which, in addition to a portion of chromium, also has an iron portion. Here, an iron portion of the nickel-based alloy in a range of about 0.5 to 10 wt %, preferably about 8 wt %, has been shown to be beneficial.

It is further advantageous if a nickel-based alloy is used which also has an aluminum portion. Here, an aluminum portion of the nickel-based alloy in a range of about 0.05 to 5 wt % has been shown to be beneficial.

The use of a composite wire having an outer diameter of the jacket in a range of about 0.05 to 0.4 mm, preferably about 0.2 mm, is advantageous. A platinum portion (per unit length) in a range of about 10 to 50 wt % has proven beneficial.

To manufacture a composite wire according to the invention, round stock, for example, made of a nickel-based alloy is used, preferably with a portion of chromium in a range of about 16-22 wt %, which later forms the core material. A tube made of platinum-containing metal is pulled as a jacket onto the round stock, in which the rod-tube arrangement is drawn through a hard metal drawing die to a diameter of approximately 6 to 20 mm, preferably to a diameter of about 8 to 12 mm. Then, the rod-tube arrangement is drawn in four to five intermediate stages to a final diameter of about 0.05 mm to 0.4 mm, preferably about 0.20 mm, wherein after each deformation a diffusion-annealing step is performed at a temperature of approximately 1000° C. Consequently, from a rod of this type a connection wire provided with a jacket can be produced, which is suitable as a supply line or connection wire for measuring resistors.

The invention will now be explained with reference to the following specific, non-limiting example and the drawing.

According to the sole FIGURE, the core 1 of the composite wire is made of a nickel-based alloy, which self-passivates at the core surface, preferably a nickel-chromium-iron or a nickel-chromium alloy. Advantageously, a nickel-chromium alloy with weight percentage portions of 80:20% are used, in order to prevent the diffusion of nickel atoms in the core material through the platinum jacket 2 up to a temperature of about 750° C. As a result, the connection wire can maintain its function for a period of more than 2000 operating hours at a temperature of up to about 750° C.

The core of the composite wire 1 is enclosed according to the FIGURE by a platinum jacket 2 whose thickness lies in a range of about 1 μm to 50 μm, preferably a jacket thickness of about 8 μm.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A composite wire comprising an alloy core enclosed by a platinum-containing jacket, wherein the core comprises a nickel-based alloy which self-passivates at the core surface, and wherein the nickel-based alloy has a chromium portion in a range of about 16 to 22 wt % of the alloy.

2. A composite wire comprising an alloy core enclosed by a platinum-containing jacket, wherein the core comprises a nickel-based alloy which self-passivates at the core surface, and wherein the nickel-based alloy includes iron and chromium portions.

3. The composite wire according to claim 2, wherein the iron portion of the nickel-based alloy lies in a range of about 0.5 to 10 wt % of the alloy.

4. A composite wire comprising an alloy core enclosed by a platinum-containing jacket, wherein the core comprises a nickel-based alloy which self-passivates at the core surface, and wherein the nickel-based alloy has an aluminum portion.

5. The composite wire according to claim 4, wherein the aluminum portion of the nickel-based alloy lies in a range of about 0.05 to 5 wt % of the alloy.

6. The composite wire according to claim 2, wherein chromium portion of the nickel-based alloy lies in a range of about 16 to 22 wt % of the alloy.

7. The composite wire according to claim 1, wherein chromium portion of the nickel-based alloy is about 20 wt % of the alloy.

8. The composite wire according to claim 1, wherein the jacket has an outer diameter of about 0.05 to 0.4 mm.

9. The composite wire according to claim 8, wherein the outer diameter of the jacket is about 0.2 mm.

10. The composite wire according to claim 1, wherein the platinum comprises about 10 to 50 wt % per unit length of the wire.

11. In an electrical temperature sensor comprising a temperature measuring resistor and at least one connection wire, the improvement comprising the connection wire being a composite wire comprising an alloy core enclosed by a platinum-containing jacket, wherein the core comprises a nickel-based alloy which self-passivates at the core surface.

12. The temperature sensor according to claim 11, wherein the nickel-based alloy has a chromium portion in a range of about 16 to 22 wt % of the alloy.

13. The temperature sensor according to claim 12, wherein the chromium portion of the nickel-based alloy is about 20 wt % of the alloy.

14. The temperature sensor according to claim 11, wherein the nickel-based alloy has an iron portion in addition to the chromium portion.

15. The temperature sensor according to claim 14, wherein the iron portion of the nickel-based alloy lies in a range of about 0.5 to 10 wt % of the alloy.

16. The temperature sensor according to claim 11, wherein the nickel-based alloy has an aluminum portion.

17. The temperature sensor according to claim 16, wherein the aluminum portion of the nickel-based alloy lies in a range of about 0.05 to 5 wt % of the alloy.

18. The temperature sensor according to claim 11, wherein the jacket has an outer diameter of about 0.05 to 0.4 mm.

19. The temperature sensor according to claim 18, wherein the outer diameter of the jacket is about 0.2 mm.

20. The temperature sensor according to claim 11, wherein the platinum comprises about 10 to 50 wt % per unit length of the wire.
